(19) United States
(12) Patent Application Publication
(10) Pub. No.: US 2021/0053869 A1
(43) Pub. Date: Feb. 25, 2021

(54) Solar Glass And Method For Its Production

(71) Applicant: arcon Flachglas-Veredlung GmbH & Co. KG, Feuchtwangen (DE)

(72) Inventors: Hermann Dehner, Neuendettelsau (DE); Franz Schaumberger, Aschach/Steyr (AT)

(21) Appl. No.: 16/963,159

(22) PCT Filed: Jan. 21, 2019
(86) PCT No.: PCT/EP2019/051379

§ 371 Date: Jul. 17, 2020

(30) Foreign Application Priority Data
Jan. 26, 2018 (DE) 10 2018 101 816.9

(51) Int. Cl. C03C 17/36; C23C 14/04; C23C 14/35; C23C 14/06; C23C 14/08; C23C 14/18; C23C 14/54; G02B 5/26; G02B 5/20; G02B 5/00

(52) U.S. Cl. CPC C03C 17/366; C03C 2218/34; C03C 17/3626; C03C 17/3639; C03C 17/3644; C03C 17/3652; C03C 17/3681; C23C 14/042; C23C 14/352; C23C 14/0676; C23C 14/086; C23C 14/185; C23C 14/085; C23C 14/083; C23C 14/542; G02B 5/26; G02B 5/208; G02B 5/003; C03C 2217/91; C03C 2218/156; C03C 17/3618

(57) ABSTRACT

A solar glass is specified. In an embodiment a solar glass includes a glass substrate and a layer system arranged on the glass substrate, wherein the layer system includes a base layer comprising one or more first dielectric layers, a first silver layer arranged on the base layer, an absorber layer arranged on the first silver layer, the absorber layer comprising a metal or metal alloy, an aluminum oxynitride layer arranged on the absorber layer, an intermediate layer arranged on the aluminum oxynitride layer, the intermediate layer comprising one or more second dielectric layers, a second silver layer arranged on the intermediate layer and a cover layer arranged on the second silver layer, the cover layer comprising one or more third dielectric layers, and wherein the absorber layer has a spatially varying thickness, a spatially varying material composition and/or a spatially varying surface coverage density in at least one direction.

This patent application is a national phase filing under section 371 of PCT/EP2019/051379 filed Jan. 21, 2019, which claims the priority of German patent application 102018101816.9, filed Jan. 26, 2018, each of which is incorporated herein by reference in its entirety.

### TECHNICAL FIELD

The invention relates to a solar glass in which the total energy transmittance (g-value) and the light transmission vary in at least one direction, and a method for its production.

### BACKGROUND

The three most important parameters of a layer system for thermal or solar protection glazing according to the standards EN 410, EN 673 and EN 12898 are light transmission LT, total energy transmittance (g-value) and emissivity c. The emissivity c is a measure of the infrared heat reflectivity. The light transmission L_{T} indicates the percentage of visible light that can pass through the glazing. The g-value describes the sum of secondary heat emission to the inside and transmitted solar energy. For example, a g-value of 0.5 means that 50% of the radiated energy reaches the space behind the glass pane. Low emissivity results in good thermal insulation, small g-values provide good solar protection. The quotient of Lₜ and the g-value is the selectivity S of a layer. The selectivity S=L_{T}/g should be as high as possible for solar protection layers.

Solar protection layers with a low g-value generally also have low light transmission, as the selectivity cannot be increased at will without having to accept significant losses in color neutrality in transmission. If a large part of the solar energy input is not to be transmitted, there are two options for dealing with the radiation: It can either be reflected or absorbed. However, the building user rarely wants to perceive his façade as a mirror. It is therefore advantageous to absorb the visible part of the solar radiation in the layer system as far as possible in order to achieve a low reflection. Solar protection glazing with a low g-value therefore contains one or more absorber layers in addition to the silver layers and the protective and anti-reflective dielectric layers, especially oxides, nitrides or oxynitrides.

Layer systems for solar or thermal protection are therefore usually composed of transparent dielectric layers in which the refractive index n is much greater than the extinction coefficient k, of precious metal layers, usually silver, in which k is much greater than the refractive index n, and of absorber layers in which n and k are of the same order of magnitude.

A layer system for solar glass with an absorber layer, which is used in particular for the specific adjustment of the g-value, is known from the publication DE 10 2013 111 178 A1, for example.

Particularly in the case of large-area architectural glazing, there may be a desire for different optical properties of the solar glass in different areas of the glazing.

### SUMMARY

Embodiments provide a solar glass in which the total energy transmittance varies spatially over the area of the solar glass. Further embodiments provide a method by which such a solar glass can be produced.

According to at least one embodiment, the solar glass has a glass substrate to which a layer system is applied. The layer system starts in the direction of growth with a base layer. The growth direction is the direction from the substrate to the surface of the layer system. The base layer preferably directly adjoins the substrate of the layer system and in particular comprises one or more dielectric layers. The base layer may in particular contain one or more oxide, nitride or oxynitride layers. The glass substrate of the layer system is preferably a glass pane, in particular a float glass pane.

The base layer is followed by a first silver layer in the layer system. The silver layer serves in particular to reflect infrared radiation in order to achieve solar protection. The silver layer can have a thickness between 5 nm and 20 nm, for example.

The silver layer is followed in the direction of growth by an absorber layer of a metal or metal alloy. The absorber layer is advantageously directly adjacent to the silver layer. The absorber layer is advantageously a purely metallic layer, i.e., it consists only of metal or a metal alloy. The absorber layer is therefore especially not an oxide, oxynitride or nitride layer.

In the direction of growth, the absorber layer is preferably followed by an aluminum oxynitride layer, which serves in particular to protect the absorber layer against oxidation in subsequent process steps and is advantageously directly adjacent to the absorber layer. Because the aluminum oxynitride layer protects the absorber layer from oxidation in subsequent process steps, the purely metallic character of the absorber layer is retained even if the layer system is exposed to process steps in which the risk of oxidation of the metal layers could occur. Such a process can be, in particular, a thermal tempering process, in which a glass pane coated with the coating system is processed into, for example, toughened safety glass or partly tempered glass.

The aluminum oxynitride layer is followed by an intermediate layer in the layer system, which has one or more dielectric layers. Like the base layer, the intermediate layer is made up of one or more oxide, oxynitride or nitride layers, for example.

In the layer system, the intermediate layer is followed in the growth direction by a further silver layer which, like the first silver layer, is between 5 nm and 20 nm thick, for example. Like the first silver layer, the further silver layer functions as an optical functional layer, whereby the combination of at least two silver layers in the layer system results in a low total energy transmittance (g-value) and thus good solar protection.

It is possible that the layer system contains more than just two silver layers. For example, a further silver layer in the layer system can be followed by another intermediate layer and another silver layer. In other words, the layer system has two or more silver layers, each separated by intermediate dielectric layers.

The further silver layer or, in the case of more than two silver layers, the uppermost silver layer of the layer system is followed by a cover layer which, like the base layer and the at least one intermediate layer, has one or more dielectric layers. The dielectric layers of the base layer, of the at least one intermediate layer and of the cover layer serve, on the one hand, to protect the metallic silver layers, in particular against oxidation, and, on the other hand, to reduce the reflection of the layer system and thus to achieve a high degree of light transmission. The optimization of the layer system with regard to the lowest possible reflection is carried out in particular by means of computer-based methods in which the thicknesses of the individual layers are optimized. Such optimization methods and suitable software are known to a person skilled in the art and are therefore not explained in detail.

In solar glass, the absorber layer has a spatially varying thickness in at least one direction according to at least one embodiment. According to another possible embodiment, the absorber layer has a spatially varying surface coverage density. According to yet another possible embodiment, the absorber layer has a spatially varying material composition. In other words, the thickness, the surface coverage density and/or the material composition of the absorber layer is not constant over the entire surface of the solar glass, but at least one of these values has a gradient in at least one direction of the solar glass.

In this way, the parameter of the total energy transmittance (g-value), which is particularly important for solar glass, is varied in at least one direction of the solar glass. Furthermore, the light transmission L is also spatially varied in this way. In particular, high light transmission Lₜ can be achieved with a high g-value and correspondingly low light transmission Lₜ with a low g-value.

The variation of the g-value and the light transmission Lₜ in at least one direction of the solar glass makes it advantageously possible to achieve different optical properties in different areas of the solar glass, which could otherwise only be achieved with separately produced panes. This is particularly advantageous for architectural glazing. Large panes, especially room-high ones, are increasingly being used for building glazing. It is even conceivable to realize solar glass at the height of several floors. In the case of large panes, it may be desirable to achieve low transmission and a low g-value in certain areas, for example in a lower and/or upper area of a window with solar glass, for example in the parapet or ceiling area, in order to achieve visual protection and/or good solar protection. On the other hand, in a visible area, for example in the middle of the window (such as at eye level), it is desirable to achieve high light transmission. These different functions can be achieved in different areas of a single pane of glass with the solar glass described here. In this way, for example, it is no longer necessary to provide a separate pane in an area where low transmission is required to provide visual protection.

In particular, it has been found to be advantageous that a spatial variation in the thickness and/or the surface coverage density of the absorber layer has an effect on the light transmission and the g-value when the absorber layer is positioned on the first silver layer, but the other optical properties do not or only slightly change.

For example, despite a spatially varying g-value, it is possible to achieve an almost homogeneous, for example blue glass reflection color, a neutral transmission color and a low internal reflection. The solar glass therefore has the advantage that the solar glass can first be optimized in terms of optical properties such as in particular the color appearance, for example the color of the residual reflection or the transmitted light, without taking the absorber layer into account, and that then the parameters of light transmission and the g-value, which are essential for solar protection, can be adjusted differently for different areas of the solar glass according to the respective application by means of the spatially varying thickness of the absorber layer.

According to at least one configuration, the g-value of the solar glass has a maximum value gₘₐₓ at a first position and a minimum value gₘᵢₙ at a second position, where gₘₐₓ−gₘᵢₙ≥is 0.05. In this case, the gradient of the g-value is so large that the g-values at the first position and the second position differ from each other by at least 0.05. In a further preferred configuration, the g-value of the solar glass has a maximum value gₘₐₓ at a first position and a minimum value gₘᵢₙ at a second position, where gₘₐₓ−gₘᵢₙ is 0.1. Especially preferred is gmax−gmin≥0.2 or even≥0.3.

The spatially varying g-value of the solar glass preferably has values in the range between 0.05 and 0.45, particularly preferred in the range between 0.2 and 0.35.

The spatial variation of the g-value is associated with a spatial variation of the light transmission L_{T} of the solar glass. In particular, the g-value and the light transmission are positively correlated, i.e., with increasing g-value the light transmission also increases and vice versa. The solar glass preferably has a spatially varying light transmission L_{T} in the range between 0 and 0.8, and particularly preferably in the range between 0.4 and 0.7.

The thickness of the absorber layer preferably has values in a range between 0.5 nm and 50 nm.

The absorber layer, according a preferred configuration, consists of a metal or metal alloy with at least one of the elements Ni, Cr, Nb or Ta. In particular, the absorber layer may comprise a NiCr metal alloy, for example a NiCr metal alloy containing 80% Ni and 20% Cr.

The solar glass may be intended in particular for architectural glazing. In this case, the glass substrate may be in particular a flat glass pane, for example a float glass pane. The solar glass may be intended, for example, as a component of a window or facade element. In particular, the glass substrate may have a width of at least 3 m and a length of at least 3 m, at least 5 m or even at least 6 m. Lengths of up to 18 m are conceivable, for example. In this case, the glass substrate can be, for example, a pane of glass intended for glazing several floors of a building.

A method for the production of the solar glass is also specified. In this process the layer system is preferably produced by sputtering in a sputtering plant, in particular by magnetron sputtering. In this way, the coating system can be applied to the glass substrate cost-effectively in a continuous process over a large area.

According to one embodiment, sputtering is performed in a sputtering system in which the glass substrate is transported during sputtering. In particular, the sputtering system can be a so-called in-line sputtering system in which the glass substrate is moved in a linear motion under the sputtering cathodes.

To produce the spatially varying thickness of the absorber layer, the transport speed of the glass substrate is preferably varied during the sputtering of the absorber layer. In particular, a greater thickness of the absorber layer is obtained in a region of the glass substrate which is moved more slowly under the sputtering cathode for the absorber layer than in a region of the glass substrate which is moved more quickly under the sputtering cathode. By continuously varying the transport speed, a continuous gradient of the absorber layer thickness can be generated. For example, the transport speed can be varied in the range from 1 m/min to 8 m/min, preferably in the range from 2 m/min to 4 m/min. The variation of the layer thickness by varying the transport speed can be advantageously generated by using the appropriate control software for the conveyor belt in the sputtering system. In this configuration, the thickness of the absorber layer varies in a direction parallel to the transport direction.

According to a further configuration, the electrical power for sputtering the absorber layer is varied over time to produce the spatially varying thickness of the absorber layer. By continuously varying the power, a continuous gradient of the thickness of the absorber layer can be generated. The sputtering power can be varied, for example, in the range from 20 kW to 200 kW.

According to another configuration, sputtering is performed in a sputtering system which, in order to produce the spatially varying thickness of the absorber layer, has at least one aperture between a cathode provided for sputtering the absorber layer and the glass substrate. The at least one aperture may, for example, define an opening whose size varies in the transport plane perpendicular to the transport direction. For example, an aperture may be provided which has a smaller opening in a central region of the cathode than at the edges. In this example, less absorber layer material is deposited in the center of the glass substrate than at the edges. In this way, an absorber layer is deposited whose thickness is less in a central area than at the edges. In this configuration, the thickness of the absorber layer varies in the transport plane in a direction perpendicular to the transport direction.

According to a further embodiment, sputtering is performed in a magnetron sputtering system, whereby an in homogeneous magnetic field is used to generate the varying thickness of the absorber layer. In a magnetron sputtering system, magnets are arranged behind the sputter cathodes which deflect electrons on spiral paths and thus increase the number of ionizing impacts. By applying an inhomogeneous magnetic field to the sputter cathode of the absorber layer, it can be achieved that the sputter rate varies over the surface of the sputter cathode and thus in at least one direction. With this configuration, the layer thickness of the absorber layer can be varied, in particular in a direction perpendicular to the transport direction of the glass substrate in the sputtering system.

According to further embodiment, sputtering is carried out in a magnetron sputtering system, whereby an in homogeneous process gas is used. The process gas for sputtering can be argon, for example. The process gas can be introduced into the sputtering system through spatially distributed inlet nozzles. Due to a spatially different inlet of the process gas, it is possible to create an inhomogeneous distribution of the process gas when sputtering the absorber layer. In this way, the deposition of the absorber layer with a spatially varying thickness can be achieved.

According to further embodiment, a cathode is used for sputtering the absorber layer, the material composition of which varies in one direction, especially in the direction perpendicular to the transport direction of the glass pane. In this way, an absorber layer whose material composition varies in one direction can be produced by sputtering. Preferably, the cathode has NiCr, the proportion of Ni varying in one direction of the cathode. For example, the proportion of Ni in the center of the cathode may be lower than at the edge of the cathode. This is an advantageous way of ensuring that the absorber layer deposited by sputtering with the cathode has a lower nickel content in the center of the glass substrate than at the edges of the glass substrate. This changes the g-value and the light transmission in the center of the glass substrate compared to the edges.

The mask dots preferably have lateral dimensions of not more than 3 mm, especially in the range between 0.5 mm and 3 mm. In this case, the structuring of the absorber layer caused by masking is usually hardly or not at all visible in architectural glass. For example, the mask dots are circular with diameters of no more than 3 mm or preferably no more than 1 mm.

A line mask can be used as an alternative to a point mask. In this case, in particular the number of lines per unit area and/or their width varies over the area of the glass substrate varies.

The mask layer can, for example, be a water-soluble mask material and is preferably applied by screen printing or digital printing. After applying the mask layer to the part of the layer system below the absorber layer, the absorber layer is applied by sputtering. Subsequently, the part of the absorber layer on the mask layer is detached, preferably by a lift-off process. The mask layer can, for example, have a water-soluble mask material, so that detaching can be done by rinsing with water. After the previously masked areas have been detached, the absorber layer has, for example, a hole pattern, whereby the holes in the absorber layer correspond to the previously applied mask dots. In areas with a higher surface coverage density of the mask dots, the absorber layer thus has a higher hole density than in areas where the mask layer had a lower surface coverage density of the mask dots. In this way, it is advantageously possible to produce an absorber layer whose surface coverage density varies in at least one direction.

### BRIEF DESCRIPTION OF THE DRAWINGS

The invention is explained in more detail in the following on the basis of exemplary embodiments in connection with FIGS. 1 to 3.

In the Figures:

FIG. 1 shows a schematic representation of a cross-section through a solar glass with a layer system according to an exemplary embodiment;

FIG. 2A is a top view of an example of an exemplary embodiment of the solar glass;

FIG. 2B shows a course of the thickness dA of the absorber layer in the vertical direction z in an exemplary embodiment;

FIG. 2C shows a course of the nickel concentration c_{Ni} of the absorber layer in the vertical direction z in a further exemplary embodiment;

FIG. 3A shows the solar glass in an intermediate step of an exemplary embodiment of the method for producing the solar glass; and

FIG. 3B shows a course of the surface coverage density A of the absorber layer in the vertical direction z in an exemplary embodiment.

### DETAILED DESCRIPTION OF ILLUSTRATIVE EMBODIMENTS

Like or likely acting components are marked with the same reference signs in the figures. The components shown and the proportions of the components to each other are not to be regarded as true to scale.

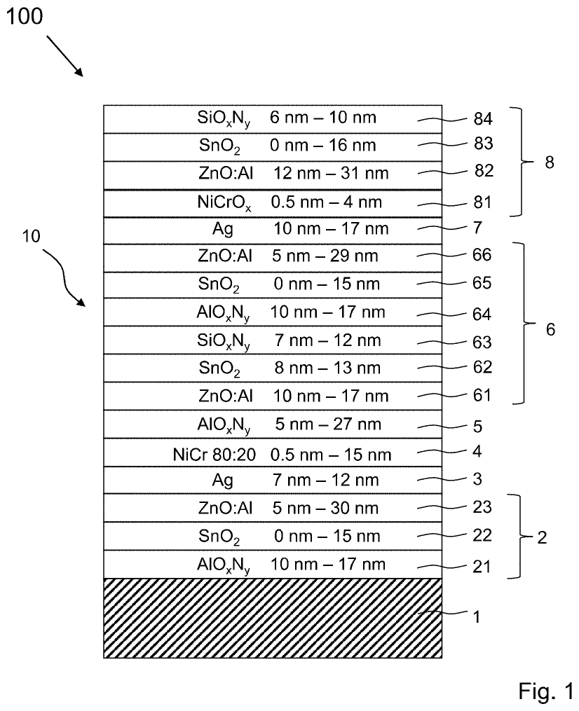

The solar glass shown in FIG. 1 has a glass substrate 1, which may in particular be a float glass pane. On the glass substrate 1 a layer system 10 is applied, which serves in particular to protect against solar radiation.

The layer system 10 comprises a base layer 2 applied to the substrate 1, which is formed from several dielectric layers 21, 22, 23. The first layer on the substrate 1 in the growth direction of the layer system 10 is an aluminum oxynitride layer 21, which has a thickness between 10 nm and 17 nm, for example. The aluminum oxynitride layer 21 functions advantageously as a diffusion barrier which reduces diffusion of components of the glass substrate 1, for example sodium, into the layer system 10 and diffusion of components of the layer system 10 into the glass substrate 1. This is followed by a layer 22 of SnO₂, which can have a thickness between 0 nm and 15 nm. The uppermost layer of the base layer 2 is a ZnO:Al layer 23, which can have a thickness between 5 nm and 30 nm, for example.

On top of the cover layer 23 of base layer 2 a first silver layer 3 has been grown, which for example has a thickness between 7 nm and 12 nm. The silver layer 3 is a first of two optical functional layers 3, 7, which serve in particular for the reflection of heat radiation.

The first silver layer 3 is followed in the direction of growth by a metallic absorber layer 4, which consists of a metal or a metal alloy and does not contain any silver. In particular, the absorber layer may be directly adjacent to the silver layer 3. The absorber layer is preferably a NiCr layer. For example, the absorber layer may contain 80% Ni and 20% Cr.

In the layer system described herein, the absorber layer 4 is produced in such a way that it has a spatially varying thickness, a spatially varying surface coverage density and/or a spatially varying material composition in at least one direction. In this way, the g-value and the light transmission L_{T} are advantageously varied in at least one direction of the solar glass.

The absorber layer 4 is followed in the growth direction by a layer of aluminum oxynitride, which preferably directly adjoins the absorber layer 4. The layer 5 of aluminum oxynitride preferably has an oxygen content between o and 30% and a thickness of, for example, 5 nm to 27 nm. Layer 5 of aluminum oxynitride protects the absorber layer 4 advantageously against corrosion, especially oxidation. This has the advantage that the purely metallic character of the absorber layer 4 is retained even if the layer system 10 is subjected to a temperature treatment.

Layer 5 of the aluminum oxynitride is followed by an intermediate layer 6, which is formed by several dielectric layers 61, 62, 63, 64, 65, 66.

In the exemplary embodiment, the intermediate layer 6 contains, in the growth direction, a ZnO:Al layer 61 with a thickness of 10 nm to 17 nm, a SnO₂ layer 62 with a thickness of 8 nm to 13 nm, a SiOₓN_{y} layer 63 with a thickness of 7 nm to 12 nm, an AlOₓN_{y} layer 64 with a thickness of 10 nm to 17 nm, a SnO₂ layer 65 with a thickness of 0 nm to 15 nm and a ZnO:Al layer 66 with a thickness of 5 nm to 29 nm. In the case of a layer with a minimum thickness specification of 0 nm, this means here and below that this layer could be optionally omitted.

On the uppermost layer 66 of the intermediate layer 6 a further silver layer 7 is arranged, which has a thickness between 10 nm and 17 nm, for example. The first silver layer 3 and the second silver layer 7 of the layer system serve in particular to reflect infrared radiation and are therefore essential optical functional layers of the solar glass.

The second silver layer 7 is followed by a cover layer 8 in the direction of growth. The cover layer 8 contains a NiCrOₓ layer 81, which is applied directly to the other silver layer 7 and preferably has a thickness between 0.5 nm and 4 nm. This suboxidic NiCrOₓ layer 81 serves in particular to protect the second silver layer 7 from oxidation.

The cover layer 8 is followed in the direction of growth by a ZnO:Al layer 82 with a thickness between 12 nm and 31 nm and a SnMayer 83 with a thickness between 0 nm and 16 nm.

The last layer of layer system 10 in the direction of growth is advantageously a SiOₓN_{y} layer 84, which preferably has a thickness between 6 nm and 10 nm. This last layer 84 of the layer system in the growth direction protects the layer system in particular against oxidation.

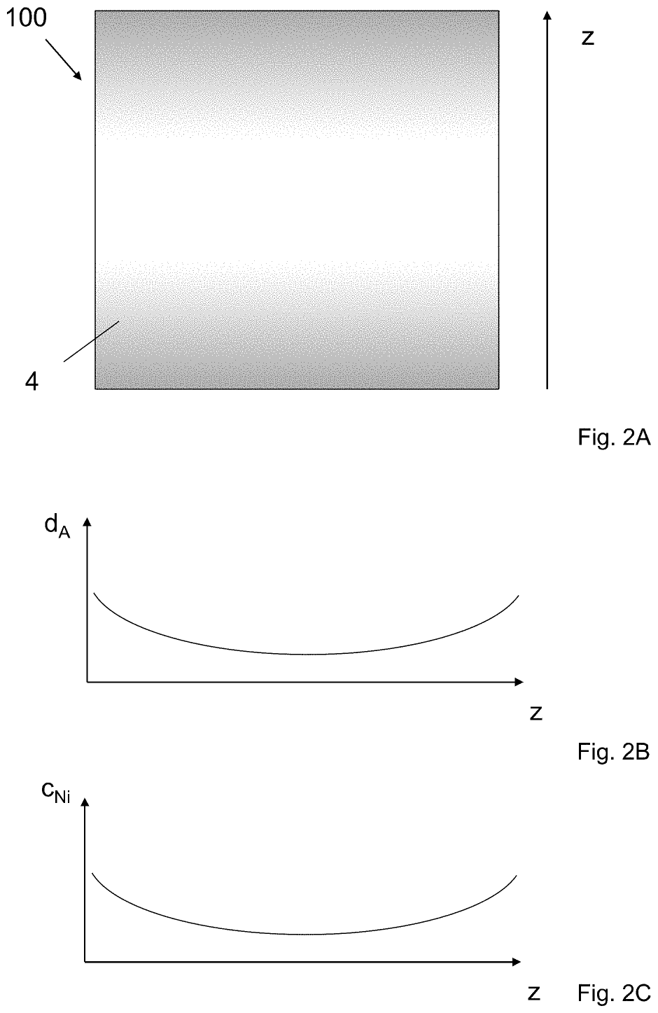

FIGS. 2A to 2C schematically illustrate possible configurations of the gradient of the absorber layer in the layer system of the solar glass 100. FIG. 2A shows a top view of an example of the design of solar glass 100. The shading shows the gradient of the thickness of the absorber layer 4 in the layer system 10 of the solar glass. Here, the light area in the middle has a smaller thickness of the absorber layer than the darker areas at the upper and lower edge of the solar glass 100. This ensures that the g-value in the layer system varies.

The solar glass 100 can, for example, be a window pane that is intended for use as solar control glazing. The exemplary embodiment of solar glass 100 can be a room-high window pane, for example. The direction z shown is the vertical direction of the solar glass 100, which may correspond to the height above the floor, for example. The absorber layer has a high transparency in the central area of the window pane, which corresponds in particular to the visible area. In the upper and lower area of the solar glass 100, on the other hand, the absorber layer has a greater thickness, so that the g-value and light transmission in these areas are lower. In this way, it can be achieved in particular that the input of solar energy is not too great in the middle area despite the high transparency and the associated low g-value. For example, the lower transparency in the floor area can be used to achieve visual protection.

A possible course of the thickness d_{A} of the absorber layer in the direction z is shown schematically in FIG. 2B. The absorber layer has a greater thickness than in the middle of the solar glass for small and large values for z, i.e., for example in the lower and upper areas of the solar glass 100.

As an alternative to the spatial variation of the thickness of the absorber layer, a spatial gradient of the g-value and the light transmission can be achieved by a spatial variation of the material composition of the absorber layer. For example, the absorber layer may contain NiCr, where the concentration of nickel c_{Ni} varies in the z direction. As shown in FIG. 2C, the concentration of nickel is greater than in the central region at small values and large values of the vertical coordinate z, i.e., for example in the floor and ceiling region of the solar glass 100. In this way, the g-value and the light transmission in the central area of the solar glass are greater than in the lower or upper area.

The variation of the thickness of the absorber layer according to FIG. 2B and the variation of the concentration of nickel according to FIG. 2C are thus two alternative ways of realizing a gradient of the g-value and light transmission in the solar glass 100.

A gradient of the thickness of the absorber layer as in the example of FIG. 2B can be created in the production of the layer system of the solar glass 100 by one of the technical measures described above, in particular by varying the sputtering power when sputtering the absorber layer, by varying the transport speed of the glass, by one or more apertures between the cathode provided for sputtering the absorber layer and the glass substrate, by an inhomogeneous magnetic field in the sputtering system or by an inhomogeneous process gas in the sputtering system.

A gradient of the nickel concentration as in the example of FIG. 2C can be generated as described above by an inhomogeneous cathode in which, for example, the nickel content varies in a direction perpendicular to a transport direction of the glass substrate in the sputtering system.

The gradients of the thickness of the absorber layer or the nickel concentration shown in FIGS. 2A to 2C, which have a minimum in the middle of the glass substrate and a maximum at the edges, are purely exemplary. Of course, depending on the application of the solar glass, any other gradients of thickness or concentration of e.g., nickel in the absorber layer can be produced. In particular, it is possible to create a gradient in two directions. This can be achieved, for example, by combining a method for generating a gradient parallel to the transport direction of the glass substrate in the sputtering system with a method for generating a gradient perpendicular to the transport direction of the glass substrate. For example, the transport speed during sputtering of the absorber layer can be varied to produce a spatially varying thickness parallel to the transport direction, and at the same time an aperture between the cathode and the glass substrate can be used to produce a thickness gradient in the direction perpendicular to the transport direction.

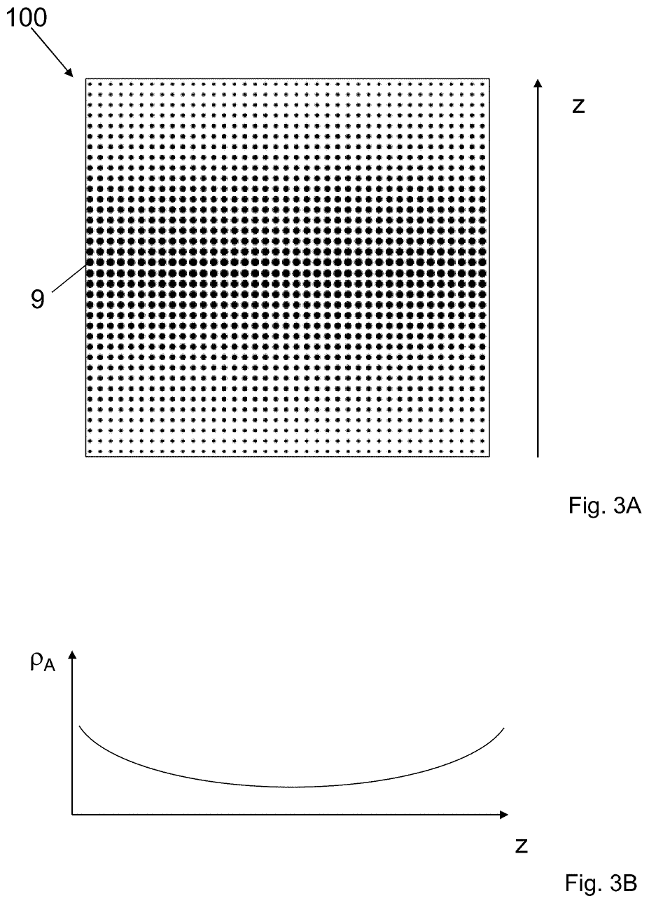

FIG. 3A shows a top view of the solar glass 100 at an intermediate step of the process for producing the solar glass before the application of the absorber layer. In this exemplary embodiment of the method, a mask layer 9 is applied to the layer below, in particular to the first silver layer of the layer system, before the absorber layer is applied. In the exemplary embodiment, mask layer 9 is designed as a dot mask in which the mask dots have a spatially varying size. As can be seen in FIG. 3A, the size of the mask dots varies, for example, in the vertical z-direction in such a way that the mask dots in the center of the solar glass 100 are larger than at the lower and upper edges of the solar glass. With an alternative design, instead of the size of the mask dots, their density could be varied spatially. The size of the mask dots of mask layer 9 is preferably not more than 3 mm, especially in the range of 0.5 mm to 3 mm. Such a small size of the mask dots has the advantage that the structuring of the absorber layer is essentially not visible in architectural glass.

The mask dots of mask layer 9, for example, can be formed from a water-soluble mask material, preferably applied by screen printing. The absorber layer is subsequently applied to mask layer 9 by sputtering. The areas of the absorber layer covered by the mass dots are then lifted off by a so-called lift-off process, so that the absorber layer remains only in those areas that were not previously covered by the mask dots.

In this way, a spatially varying surface coverage density A of the absorber layer is generated, as shown in FIG. 3B as an example. In particular, in this example, the surface coverage density A can vary in the vertical direction Z in such a way that it is maximum in the lower and upper area of the solar glass 100 and minimum in the center of the solar glass 100. The effect on the g-value and light transmission in this case is comparable to the exemplary embodiments in FIGS. 2A to 2C, i.e., with such a solar glass a high g-value combined with a high light transmission is achieved in the center and a low g-value combined with a low light transmission in the lower and upper area.

By a different choice of the mask layer, of course, other gradients of the surface coverage density as well as the g-value and light transmission can be produced.

The invention is not limited by the description based on the exemplary embodiments. Rather, the invention comprises each new feature as well as each combination of features, which in particular includes each combination of features in the claims, even if this feature or combination itself is not explicitly stated in the claims or exemplary embodiments

1-18. (canceled)

19. A solar glass comprising:
a glass substrate; and
a layer system arranged on the glass substrate, the layer system comprising:
a base layer comprising one or more first dielectric layers;
a first silver layer arranged on the base layer;
an absorber layer arranged on the first silver layer, the absorber layer comprising a metal or metal alloy;
an aluminum oxynitride layer arranged on the absorber layer;
an intermediate layer arranged on the aluminum oxynitride layer, the intermediate layer comprising one or more second dielectric layers;
a second silver layer arranged on the intermediate layer; and
a cover layer arranged on the second silver layer, the cover layer comprising one or more third dielectric layers,
wherein the absorber layer has a spatially varying thickness, a spatially varying material composition and/or a spatially varying surface coverage density in at least one direction.

20. The solar glass according to claim 19 wherein a g-value of the solar glass has a maximum value gₘₐₓ at a first position and a minimum value gₘᵢₙ at a second position, and wherein gₘₐₓ−gₘᵢₙ≥0.05.

21. The solar glass according to claim 20, where gₘₐₓ−gₘᵢₙ≥is 0.2.

22. The solar glass according to claim 19, wherein a g-value of the solar glass varies in a range between 0.05 and 0.45.

23. The solar glass according to claim 19, wherein a light transmission Lₜ of the solar glass varies in a range between 0 and 0.8.

24. The solar glass according to claim 19, wherein the absorber layer has a thickness between 0.5 nm and 50 nm.

25. The solar glass according to claim 19, wherein the absorber layer comprises NiCr.

26. The solar glass according to claim 19, wherein the solar glass is a component of a window, a facade element or a vehicle pane.

27. The solar glass according to claim 19, wherein a thickness, a surface coverage density and/or a material composition of the absorber layer is not constant over the entire surface of the solar glass.

28. A method for producing the solar glass according to claim 19, the method comprising:
producing the layer system by sputtering.

29. The method according to claim 28, wherein sputtering is performed in a sputtering system in which the glass substrate is transported while sputtering, and wherein a transport speed of the glass substrate varies while sputtering to produce the spatially varying thickness of the absorber layer. 3o. (New) The method according to claim 28, wherein sputtering is performed in a sputtering system in which the glass substrate is transported while sputtering, and wherein electrical power while sputtering of the absorber layer is varied over time to produce the spatially varying thickness of the absorber layer.

31. The method according to claim 28, wherein sputtering is performed in a sputtering system which, in order to produce the spatially varying thickness of the absorber layer, has at least one aperture between a cathode provided for sputtering the absorber layer and the glass substrate.

32. The method according to claim 28, wherein sputtering is performed in a magnetron sputtering system, and wherein an inhomogeneous magnetic field is used to generate the spatially varying thickness of the absorber layer.

33. The method according to claim 28, wherein a spatially inhomogeneous process gas is used for sputtering the absorber layer.

34. The method according to claim 28, wherein a cathode whose material composition varies in one direction is used for sputtering the absorber layer.

35. The method according to claim 28, further comprising, before applying the absorber layer, applying a mask layer to the glass substrate in order to produce a spatially varying surface coverage density of the absorber layer, wherein the mask layer has a spatially varying surface coverage density.

36. The method according to claim 35, wherein the mask layer is a point mask or a line mask.

37. The method according to claim 36, wherein the mask layer is a point mask comprising mask dots having a size between 0.5 mm and 3 mm.
